(19) United States
(12) Patent Application Publication
(10) Pub. No.: US 2020/0258403 A1
(43) Pub. Date: Aug. 13, 2020

(54) SYSTEMS AND METHODS FOR IDENTIFYING AND PRESENTING DATA LAYERS RELEVANT TO A VEHICLE

(71) Applicant: Honeywell International Inc., Morris Plains, NJ (US)

(72) Inventors: Kapil RATHI, Bangalore (IN); Madhava GADICHERLA, Bangalore (IN); Saravanakumar GURUSAMY, Coimbatore (IN)

(73) Assignee: Honeywell International Inc.

(21) Appl. No.: 16/270,327

(22) Filed: Feb. 7, 2019

(51) Int. Cl. G08G 5/00; G01W 1/02

(52) U.S. Cl. CPC G08G 5/0091; G08G 5/0047; G08G 5/0021; G01W 1/02

(57) ABSTRACT

Systems and methods may be used for identifying and presenting data layers relevant to a vehicle. According to an embodiment, a method may include: receiving data describing a plurality of data layers, each of the plurality of data layers being indicative of a condition being a weather condition or a restriction zone condition; determining a relevance of each of the plurality of data layers based on a position or planned path of the vehicle and characteristics of the conditions respectively indicated by the plurality of data layers; selecting one or more relevant layers from the plurality of data layers based on the relevance respectively determined for the plurality of data layers; and presenting the one or more selected relevant data layers to an operator of the vehicle.

### TECHNICAL FIELD

Various embodiments of the present disclosure relate generally to selecting information to be displayed to an operator of a vehicle, and, more particularly, to identifying and presenting data layers relevant to the vehicle.

### BACKGROUND

A vehicle, such as an aircraft, may have access to multiple data sources pertaining to conditions of the vehicle's environment, such as weather conditions. A single data source may provide the vehicle with data describing multiple data layers that may be displayed. For example, an aircraft during flight may have access to a satellite-based weather service, which may provide multiple weather layers, and may also have access to an on-board weather radar, which may provide additional weather layers. In such circumstances, the display of many weather layers on a cockpit display system may result in an overly cluttered display, or may not be possible due to hardware limitations. Therefore, the flight crew of the aircraft may need to select only a few weather layers for display. However, the flight crew may miss important information if only a few weather layers are displayed. For example, if the flight crew chooses to display data layers of the on-board weather radar instead of data layers from a satellite-based weather service, the flight crew may become unaware of weather phenomena or a temporary flight restriction up ahead on the flight path.

Therefore, there is a need for methods and systems to select data layers so that relevant data layers are automatically displayed and brought to the attention of the operators of a vehicle. The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for used for identifying and presenting data layers relevant to a vehicle.

For instance, a method may include: receiving data describing a plurality of data layers, each of the plurality of data layers being indicative of a condition being a weather condition or a restriction zone condition; determining a relevance of each of the plurality of data layers based on a position or planned path of the vehicle and characteristics of the conditions respectively indicated by the plurality of data layers; selecting one or more relevant layers from the plurality of data layers based on the relevance respectively determined for the plurality of data layers; and presenting the one or more selected relevant data layers to an operator of the vehicle.

Furthermore, a computer system may include a memory storing instructions; and one or more processors configured to execute the instructions to perform operations. The operations may include receiving data describing a plurality of data layers, each of the plurality of data layers being indicative of a condition being a weather condition or a restriction zone condition; determining a relevance of each of the plurality of data layers based on a position or planned path of the vehicle and characteristics of the conditions respectively indicated by the plurality of data layers; selecting one or more relevant layers from the plurality of data layers based on the relevance respectively determined for the plurality of data layers; and presenting the one or more selected relevant data layers to an operator of the vehicle.

Furthermore, a non-transitory computer-readable medium storing instructions that, when executed by one or more processors, cause the one or more processors to perform a method for identifying and presenting data layers relevant to a vehicle. The method may include: receiving data describing a plurality of data layers, each of the plurality of data layers being indicative of a condition being a weather condition or a restriction zone condition; determining a relevance of each of the plurality of data layers based on a position or planned path of the vehicle and characteristics of the conditions respectively indicated by the plurality of data layers; selecting one or more relevant layers from the plurality of data layers based on the relevance respectively determined for the plurality of data layers; and presenting the one or more selected relevant data layers to an operator of the vehicle

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates an example of a system for identification and display of relevant data layers, according to one or more embodiments.

FIG. 2 illustrates a method according to one or more embodiments.

FIG. 3 illustrates an example of a display screen, according to one or more embodiments.

FIG. 4 illustrates an example of an implementation of a system for identification and display of relevant data layers, according to one or more embodiments.

FIG. 5 illustrates another example of an implementation of a system for identification and display of relevant data layers, according to one or more embodiments.

FIG. 6 illustrates another example of a display screen, according to one or more embodiments.

FIG. 7 illustrates another example of a display screen, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus.

In the following description, embodiments will be described with reference to the accompanying drawings. As noted above, an aircraft or other vehicle may have access to multiple data layers, such as weather layers, from data received from multiple data sources. In various embodiments, the relevance of individual data layers is assessed based on factors such as the position or planned path of the aircraft and characteristics of weather or other conditions indicated by the data layers. For example, weather layers that indicate insignificant weather conditions, or weather conditions that are not on the flight path of the aircraft, may be given low relevance. By assessing the relevance of individual data layers, it is possible to select only relevant layers for display. This process of assessing individual data layers and selecting relevant data layers may be automatically performed.

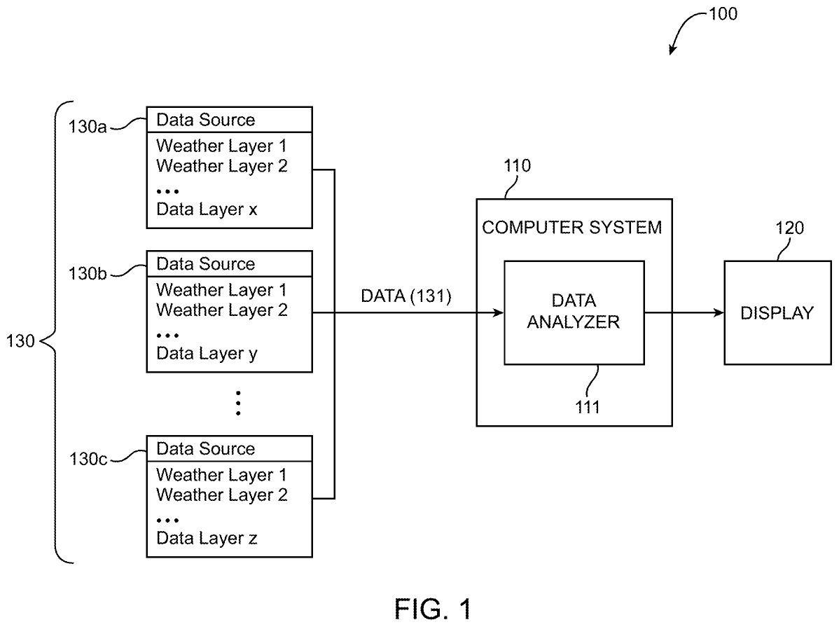

FIG. 1 illustrates an example of a system 100 for identification and display of relevant data layers, such as weather layers indicating various weather phenomena. The system 100 may include a computer system 110 configured to receive data 131 from data sources 130. The computer system 110 may have appropriate communications interfaces to receive data 131 from the data sources 130. For example, the computer system 110 may be connected to a satellite receiver to receive data from a satellite weather service. The computer system 110 may be configured to control a display 120, which may be located on-board the vehicle, to display any of the weather layers.

Examples of data sources 130 include weather radars (which may be on-board the vehicle), satellite data services (such as Sirius XM (SXM) Aviation), data centers (such as Honeywell Global Data Center), automatic dependent surveillance-broadcast (ADS-B), VHF data links, and various graphical weather uplinks. These data sources 130 may provide the computer system 110 with data 131 describing a plurality of data layers. Data sources 130 may also include a database.

The data layers described by data 131 may each be a set of data that is displayable as a layer on display 120. A data layer may be, for example, a weather layer. Examples of weather layers include Meteorological Aerodrome Reports (METARs), Airmen's Meteorological Information (AIRMETs), Significant Meteorological Information (SIGMETs), pilot reports (PIREPs), weather warnings, visibility data, and forecasts of one or more weather conditions (e.g., wind, lightning, etc.). Other examples of data layers include data layers indicating restriction zone conditions, notices to airmen (NOTAM), and any other data layer displayable on display 120. An example of a restriction zone condition is a temporary flight restriction (TFR).

A data layer may be a dynamic data layer or a static data layer. A dynamic data layer may be a displayable set of data describing a feature that is dynamic (e.g., time-varying or time-dependent). A dynamic data layer may include data that is time-indexed. Time-indexed data may include data for multiple points in time, or data for a single point in time. A dynamic data layer may be received from, for example, VHF or satellite communication. Examples of dynamic data layers include weather layers and data layers indicating temporary flight restrictions.

A static data layer may be a displayable set of data describing a feature that is static. A static data layer may include data that is not time-indexed. A static data layer may be received (e.g., loaded) from a database. Examples of dynamic data layers include data layers indicating fixed features such as terrain and airspaces.

The above categories of data layers are not mutually exclusive. For example, a data layer indicating a temporary flight restriction may also be considered to be a weather layer whenever context permits. Furthermore, when a data source 130 provides weather layers, the data source 130 may also be referred to as a weather source, regardless of whether it provides data layers other than weather layers.

For example, the data sources 130 in FIG. 1 may include a first data source 130a (e.g., an on-board radar) that provides data describing x number of data layers. These x data layers may include a plurality of weather layers, as represented by Weather Layer 1 and Weather Layer 2. The data sources 130 may also include a second data source 130b (e.g., a satellite data service) that provides data describing y data layers, and a third data source 130c (e.g., a data center) that provides data describing z layer layers. The satellite data service and the data center may each provide data describing additional data layers, such as data layer indicative of a restriction zone.

The number of layers provided by each of the data sources 130, as represented by the variables x, y, and z in FIG. 1, may depend on particular characteristics of the data source. This number may be, for example, 1 or more, 2 or more, 5 or more, 10 or more, 20 or more, or 40 or more. For example, a satellite weather service and a data center may each provide more than 20 different types of weather layers.

The computer system 110 may include a data analyzer 111 to analyze weather layers and other data layers provided by data sources 130. The data analyzer may be a software-implemented component, such as an application or group of applications executed by one or more processors of the computer system 110. Based on the weather layers received by the computer system 110 from the data sources 130, the data analyzer 111 may generate information to be displayed on display 120 by analyzing the data 131 of the data layers, and processing the data 131 so as to select a subset of data layers for display. The computer system 110 may control the display 120 to display such information.

As noted above, the display 120 may be on-board the vehicle. In various examples discussed in this disclosure, the vehicle is exemplified as an aircraft, which may be an airplane, a helicopter, an unmanned aerial vehicle (UAV), or other type of aircraft. However, as used in this disclosure, “vehicle” also encompasses land vehicles, such as automobiles, as well as watercraft, such as ships, boats, and submersible watercraft. In the context of aircraft, display 120 may be part of a cockpit display system (CDS). In such implementations, as well as various other implementations, display 120 may also be referred to a cockpit display unit.

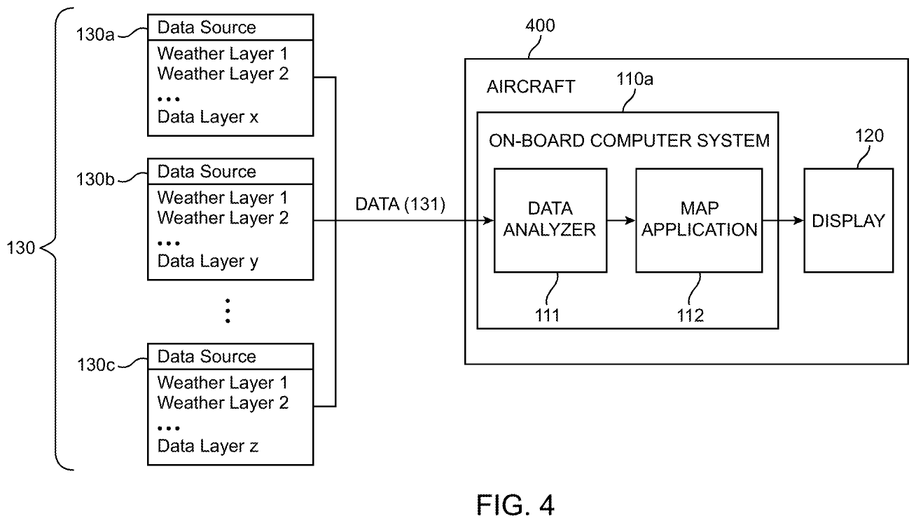

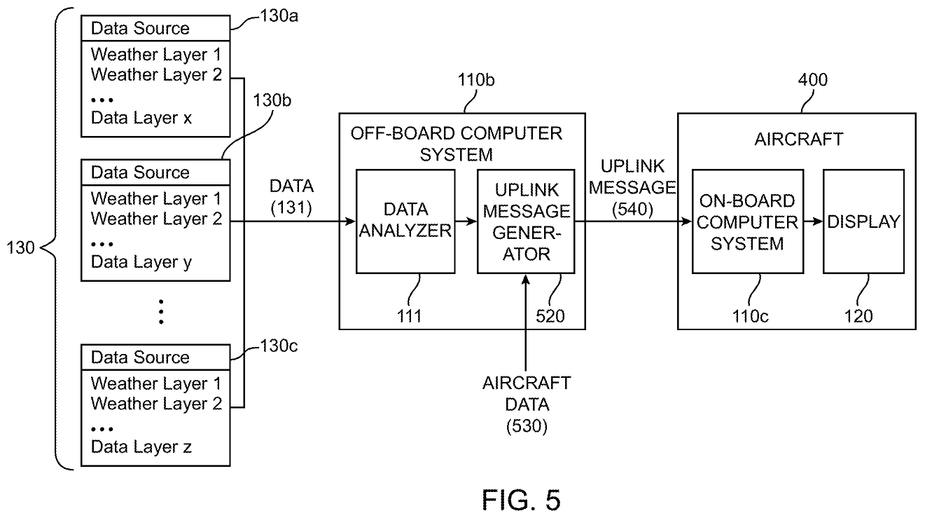

As will be described in greater detail below with reference to FIGS. 4-5, the computer system 110 may be either on-board the vehicle (e.g., aircraft), off-board the vehicle, or include a combination of on-board and off-board components. In embodiments in which the computer system 110 is on-board the vehicle, the computer system 110 may provide graphical processing capabilities to render content on the display 120, which may be on-board the vehicle. For example, as hardware implementing graphical processing capabilities, the computer system 110 may include a graphics card, graphics module, and/or graphics processing unit (GPU) configured to render one or more of the data layers described by data 131 on the display 120. The graphics card, graphics module, and/or GPU may render the data layers described by data 131 using a map application installed in the computer system 110.

In embodiments in which the computer system 110 is off-board the vehicle, the vehicle may include an on-board computer system having the graphical processing capabilities and hardware described above. In such embodiments, the computer system 110 may perform data analysis and transmit a message to the on-board computer system to thereby result in the display one or more of the weather layers described by data 131 on the display 120.

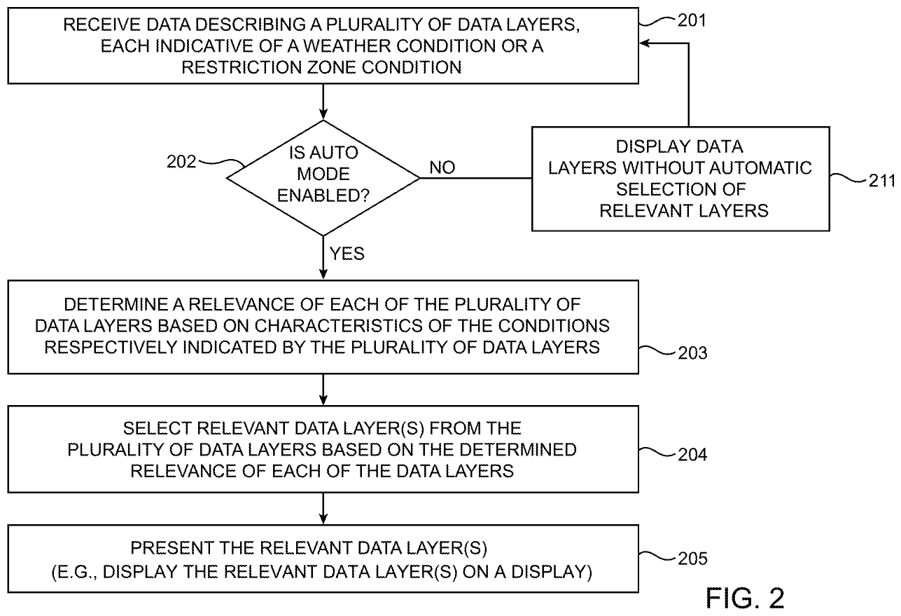

FIG. 2 is a flowchart illustrating an example of a method according to the present application. The method may be performed by the computer system 110, which may be configured to perform the method by any combination of software and/or hardware components. For example, the computer system 110 may include a memory storing instructions, and one or more processors configured to execute the instructions to perform the method.

Step 201 of the method may include receiving data describing a plurality of data layers. Each of the plurality of data layers may be indicative of a condition of the vehicle's environment that is relevant to the travel of the vehicle, such as a weather condition (e.g., presence of a weather phenomenon) or a restriction zone condition. A restriction zone condition may be the presence of a zone or area in which the vehicle is not permitted to travel by law or regulation. For example, in the context of aircraft, a condition affecting travel may be a temporary flight restriction (TFR) or other types of airspace restrictions.

The data received in step 201 may be received from one or more data sources 130. For example, the data may include first data received from a first data source describing a first plurality of data layers and second data received from a second data source describing a second plurality of data layers.

In general, the plurality of data layers in the method of FIG. 2 may include any combination of dynamic data layers and/or static data layers. However, the method of FIG. 2 may also be implemented such that the plurality of data layers is limited to only dynamic data layers, in which case static data layers may be displayed based on another process.

Step 202 may include determining whether an auto mode is enabled. The computer system 110 may provide an auto mode for automatic selection and display of data layers. The pilot or flight crew may have the option of either enabling or disabling auto mode.

When auto mode is enabled, the data analyzer 111 may continuously parse through the data layers of all available weather sources, and automatically select certain data layers for display, as described further below. For example, when auto mode is enabled, the graphics module controlling an on-board cockpit display unit may render only the layers that were selected by the data analyzer 111 as relevant.

If auto mode is not enabled (202: NO), the computer system 110 may display data layers without automatic selection of layers to be displayed (step 211). For example, the displayed layers may be layers manually selected by the operator of a vehicle.

If auto mode is enabled (202: YES), the computer system 110 may proceed to steps 203 through 205. Step 201 may be a continuously performed operation. That is, the computer system 110 may continuously monitor receipt of data from data sources 130. Accordingly, steps 201 through 205 may repeat in a continuous loop as long as the computer system 110 detects that auto mode is enabled.

Step 203 may include determining a relevance of each of the plurality of data layers based on characteristics of the conditions respectively indicated by the plurality of data layers. Step 204 may include selecting relevant data layer(s) from among the plurality of data layers based on the determined relevance of each of the received data layers. Steps 203 and 204 may also be referred to as a process for identifying a relevant subset of data layers from the set of data layers described by the data received in step 201. Steps 203 and 204 may be performed by data analyzer 111. Step 205 may include presenting the relevant data layer(s) selected according to step 204.

In step 203, the relevance of a data layer may be determined as a parameter whose value is determined as a function of one or more factors. Such parameter may also be referred to as a relevance parameter, such as a relevance score. The factors used to determine the relevance may include the characteristics of the conditions, and/or one or more parameters of the vehicle. Examples of parameters of the vehicle include the position of the vehicle, the planned path of the vehicle, the speed of the vehicle, the travel direction of the vehicle, and, in general, any kinematical property of the vehicle. In the context of aircraft, the position of a vehicle may include its altitude.

The characteristics of the conditions used for the determination of data layer relevance may include a position of the condition and the type of condition, such as whether the data layer is a weather layer or a layer indicative of a restriction zone condition.

For data layers that are weather layers indicative of weather conditions, the characteristics considered in the determination of relevance may include a severity of the weather conditions. The computer system 110 may, for example, determine a value of a parameter used to represent severity. The value of such parameter may be determined based on quantitative data indicated in the weather layer (e.g., wind speed, cloud ceiling height, and visibility), the type of weather condition indicated in the weather layer, assessments of severity provided by weather sources, and/or any other information pertinent to the determination of severity. The parameter used to represent severity may be a categorical variable (e.g., having values corresponding to various categories of severity), or as a quantitative variable. Categories of severity may be binary categories of “significant” and “not significant,” or categories representing grades of significance. In this context, “severity” and “significance” may be used interchangeably.

The severity of certain weather conditions (such as wind, cloud ceilings, and visibility) may be evaluated based on a comparison of quantified characteristics with relevant threshold conditions. For example, wind may be evaluated to be significant (or of a certain category of severity) if the wind speed is greater than a threshold (e.g., 20 knots), cloud ceilings may be evaluated to be significant (or of a certain category of severity) if the cloud ceiling of less than a certain altitude threshold (e.g., 1000 feet), and visibility may be evaluated to be significant (or of a certain category of severity) if the visibility is less than a certain threshold (e.g., 5 nautical miles). In these examples, if severity is binary so as to be either “significant” or “not significant,” then failure to satisfy the threshold condition may result in a value corresponding to “not significant.”

Certain types of weather layers may automatically be recognized as being indicative of significant weather. For example, any conditions reported in Significant Meteorological Information (SIGMETs) may be recognized by the data analyzer 111 as being significant, as opposed to insignificant.

For data layers that are indicative of a restriction zone condition, the fact that the data layer is of such type may result in a relevance that is the same, comparable to, or greater than the relevance of severe weather, when other factors, such as proximity, are equal. In some examples, the type of restriction may affect the relevance.

Relevance may be greater when there is greater proximity between the condition and the position of the vehicle, and/or when there is greater proximity between the condition and points along the planned path of the vehicle. In some examples, the data analyzer 111 may analyze all conditions (e.g., weather conditions and/or flight restrictions) to assess a value or category of proximity, and determine relevance based on the assessed value or category of proximity. For example, the data analyzer may consider proximity in the categories of: the immediate vicinity of vehicle; an upcoming portion of the flight path beyond the immediate vicinity; and the remainder of the flight path. In such examples, conditions that are otherwise equivalent in relevance factors may be given a high relevance if it is in the immediate vicinity of the vehicle, an intermediate relevance if it is in the upcoming portion of the flight path, and a low relevance if is in the remaining part of the entire flight path.

For example, the immediate vicinity of the vehicle may be positions within a certain radius (e.g., 5 nautical miles) from the position of the vehicle. The upcoming portion of the flight path may be a portion of the flight path starting from outside of the immediate vicinity of the vehicle through a certain distance (e.g., the next 25 nautical miles of the flight path outside of the 5 nautical mile radius). The remainder of the flight path may be the remaining portion of the flight path that is beyond the upcoming portion.

As another example, the categories of proximity may correspond to regions (e.g., of a certain radius) along the planned path that are progressively further from the position of the vehicle. In such examples, conditions that are otherwise equivalent in relevance factors may be given a higher relevance by belonging to a region along the planned path that is closer to the position of the vehicle.

Therefore, in step 203, the relevance of a data layer may be determined as a function of any one or more of the factors discussed above, e.g., as a function of any of the aforementioned parameters of the vehicle (position, planned path, speed, travel direction, etc.) and/or the characteristics of the condition.

The relevance may be a parameter having categorical or quantitative values that indicate a grade or degree of relevance, in which case the selection of step 204 may select layers that are at or above a certain relevance threshold. In some examples, the relevance may be a binary determination of either “relevant” or “not relevant,” and such determination may respectively determine that the data layer is or is not to be selected to be selected for display in step 204.

By computing the relevance according to step 203, the data analyzer 111 may implement a priority scheme, wherein layers of a higher relevance are given priority for purposes of display. Accordingly, conditions potentially affecting the immediate safety of a flight, for example, may be addressed first, and conditions potentially affecting later parts of the flight plan may be addressed later.

In some situations, the data layers may include duplicates. For example, TFR, SIGMET, and wind layers may be supplied by two different data sources 130. The data analyzer 111 may be configured to identify and eliminate layers that are duplicates or substantially duplicates. Factors for elimination may include weather source priority and the timestamp of individual data layers. Each of the data (e.g., weather) sources 130 may be given a priority value. For example, an on-board radar may have a higher priority than a satellite data source. The determination of duplicity may be part of the determination of relevance or a separate determination. Accordingly, the elimination of duplicate data layers may occur before, concurrently, or after the determination of relevance.

Further examples of weather layers and the determination of the relevance of weather layers are provided below. For purposes of illustration, the examples are in the format of text messages. It is understood, however, that the methodologies discussed below also apply to other data formats, such as data formats used for graphical uplink data streams.

Table 1 below shows an example of a wind weather layer. Specifically, the data of Table 1 indicates weather conditions for the Phoenix Sky Harbor International Airport (PHX) and the Cincinnati/Northern Kentucky International Airport (CVG). The data indicates the wind direction (in degrees), wind speed (in knots), and the temperature (in Celsius) at PHX and CVG for nine altitudes above sea level (in feet). The wind data for PHX and/or CVG may constitute a wind weather layer. The temperature data for PHX and/or CVG may also be considered as a weather layer, but may be given low relevance or no relevance if temperature is a weather condition of low importance.

TABLE 1

| | Altitude (ft.) | 3000 | 6000 | 9000 | 12000 | 18000 | 24000 | 30000 | 34000 | 39000 |
|---|---|---|---|---|---|---|---|---|---|---|
| PHX | Wind direction | 280 | 280 | 230 | 230 | 280 | 320 | 320 | 310 | 300 |
| | (degree) | | | | | | | | | |
| | Wind speed | 9 | 9 | 6 | 11 | 10 | 24 | 36 | 41 | 45 |
| | (knots) | | | | | | | | | |
| | Temperature | | 23 | 16 | 7 | −7 | −17 | −33 | −43 | −52 |
| | (Celsius) | | | | | | | | | |
| CVG | Wind direction | 280 | 280 | 240 | 240 | 250 | 250 | 240 | 240 | 230 |
| | (degree) | | | | | | | | | |
| | Wind speed | 12 | 9 | 26 | 32 | 27 | 29 | 40 | 45 | 41 |
| | (knots) | | | | | | | | | |
| | Temperature | | 10 | 10 | 7 | −6 | −19 | −33 | −41 | −52 |
| | (Celsius) | | | | | | | | | |

Data of the type shown in Table 1 may be received from, for example, the National Centers for Environmental Prediction (NCEP) of the National Weather Service (NWS) of the United States, or a data source that broadcasts data produced by the NCEP. The data may be in a format such as the “ddffttt” block format used by the NCEP. The data points shown in Table 1 may be extrapolated to estimate wind and temperature at other altitudes and nearby locations.

As indicated in the above data, if the vehicle is an aircraft flying at an altitude of 10000 feet in the Phoenix area, the aircraft would experience calm winds, between 6 and 11 knots. Based on the example threshold condition of greater than 20 knots in order for winds to be categorized as being significant, the data analyzer 111 may determine such winds to be not significant weather. Accordingly, the wind weather layer may be given a low value for its relevance. Therefore, when there are other weather layers that are more significant, the wind weather layer may be omitted from being displayed, and any other significant weather data/layer may be given higher priority.

On the other hand, if the aircraft is instead flying in the Cincinnati area at 10000 feet, it would experience strong winds, between 26 knots and 32 knots. Because this is significant wind, the wind layer may be given a high value for its relevance, so as to be given high priority for purposes of automatic display. In this case, the relevance may be of a value such that the wind layer is automatically selected and displayed in steps 204 and 205. On the other hand, if the aircraft is flying at an altitude of 6000 feet in the same Cincinnati area, it would experience calm winds of 9 knots. In this case, the wind weather layer may be given a low relevance, and be chosen to be omitted from being display.

As described above, the analysis of weather condition severity may be performed on the area as well as the altitude the aircraft is flying or predicted to fly (based on, for example, the flight plan). For example, if the aircraft is currently at an altitude of 600 feet in the Cincinnati area, but the flight plan indicates that the aircraft will increase altitude to 10000 feet, then the analysis may be performed for the altitude of 10000 feet.

Tables 2 and 3 show examples of METAR weather layers. Table 2 shows a METAR weather report for Phoenix Sky Harbor International Airport. Table 3 shows a METAR weather report for Cincinnati/Northern Kentucky International Airport. In Tables 2 and 3, the “text” field indicates the data received in METAR format, and the remaining fields indicate the content indicated by the MTEAR text.

TABLE 2
METAR weather report for Phoenix Sky Harbor International Airport

| | |
|---|---|
| Text | KPHX 100851Z 30008KT 10SM CLR 33/17 A2977 |
| | RMK AO2 SLP059 T03330167 51005 |
| Temperature | 33.3° C. (92° F.) |
| Dewpoint | 16.7° C. (62° F.) [RH = 37%] |
| Pressure | 29.77 inches Hg (1008.2 mb) [Sea level pressure: |
| (altimeter) | 1005.9 mb] |
| Winds | from the WNW (300 degrees) at 9 MPH (8 knots; |
| | 4.1 m/s) |
| Visibility | 10 or more sm (16+ km) |
| Ceiling | at least 12,000 feet AGL |
| Clouds | sky clear below 12,000 feet AGL |

TABLE 3
METAR weather report for
Cincinnati/Northern Kentucky International Airport

| | |
|---|---|
| Text | KCVG 100909Z 26005KT 2SM BCFG OVC004 |
| | 15/15 A2987 RMK AO2 SFC VIS 10 T01500150 $ |
| Temperature | 15.0° C. (59° F.) |
| Dewpoint | 15.0° C. (59° F.) [RH = 100%] |
| Pressure | 29.87 inches Hg (1011.6 mb) |
| (altimeter) | |
| Winds | from the W (260 degrees) at 6 MPH (5 knots; 2.6 m/s) |
| Visibility | 2.00 sm (3.22 km) |
| Ceiling | 400 feet AGL |
| Clouds | overcast cloud deck at 400 feet AGL |
| Weather | BCFG (patches of fog) |

The data in Table 2 indicates clear skies (ceiling >8000 ft.) and high visibility (>5 nautical miles) in the Phoenix area. Since these weather conditions are not significant, the METAR report could be omitted from being displayed and other weather layers given priority, if the aircraft is currently travelling or will be travelling to travel in the Phoenix area. The METAR report for Cincinnati paints a different picture with low visibility (visibility <5 nautical miles and cloud ceiling <1000 ft.) and patches of fog. Since these conditions are significant, based on the example thresholds described above, the METAR report may be given a high relevance, so as to result in be automatically chosen for display in step 204.

Some weather reports are already tagged as significant by an aviation weather authority. For example, SIGMET (Significant Meteorological Information) reports typically indicate adverse weather conditions such as thunderstorms and/or severe turbulence over a large geographical area. SIGMET reports provide a region within which the adverse weather conditions exist. As the report already provides the geographical coordinates, the coordinates may be automatically rendered on the graphical display.

For example, in the following SIGMET report, the line “FROM 70NNW BJI-20E INL-40ESE INL-50WNW DLH-20WNW BJI-70NNW BJI” indicates coordinates for graphical display. Note that BJI indicates Bemidji airport, DLH indicates Duluth airport and INL indicates Falls International Airport. “70NNW BJI” indicates 70 miles North North-West of Bemidji Airport.

Type: SIGMET Hazard: CONVECTIVE
WSUS32 KKCI 100855
SIGC
CONVECTIVE SIGMET 31C
VALID UNTIL 1055Z
MN
FROM 70NNW BJI-20E INL-40ESE INL-50WNW DLH-20WNW BJI-70NNW BJI
AREA TS MOV FROM 25025KT. TOPS TO FL420.
OUTLOOK VALID 101055-101455
AREA 1...FROM 40W INL-INL-80NNE DLH-40SSE BRD-ABR-40W INL
WST ISSUANCES POSS. REFER TO MOST RECENT ACUS01 KWNS FROM STORM
PREDICTION CENTER FOR SYNOPSIS AND METEOROLOGICAL DETAILS.
AREA 2...FROM 40SSW MCB-70SW LEV-120SSW LCH-90SE PSX-80E
BRO-BRO-60SSE LRD-LRD-DLF-4OWNW SAT-IAH-40SSW MCB
WST ISSUANCES POSS. REFER TO MOST RECENT ACUS01 KWNS FROM STORM
PREDICTION CENTER FOR SYNOPSIS AND METEOROLOGICAL DETAILS.

AIRMET (Airmen's Meteorological Information) reports indicate weather conditions, such as moderate turbulence, that are less drastic as compared to that of SIGMET. These reports may also be automatically parsed and, if relevant, display to the flight crew. An example of an AIRMET is shown below.

Type: AIRMET Hazard: TURB
WAUS45 KKCI 100845
SLCT WA 100845
AIRMET TANGO UPDT 1 FOR TURB VALID UNTIL 101500
AIRMET TURB...CO NM
FROM 40ESE LAA TO 50W LBL TO 30ESE TBE TO INK TO ELP TO 40NE TCS
TO 40SSW PUB TO 40ESE LAA
MOD TURB BTN FL260 AND FL420. CONDS CONTG BYD 15Z ENDG BY 18Z.
OTLK VALID 1500-2100Z
AREA 1...TURB NV OR CA AND CSTL WTRS
BOUNDED BY 20ENE ONP-30ESE DSD-30W REO-70WNW BAM-20SE FMG-40SE
FOT-140WSW FOT-110WSW ONP-20ENE ONP
MOD TURB BTN FL300 AND FL390. CONDS DVLPG 18-21Z. CONDS CONTG
THRU 21Z.
AREA 2...TURB ID MT WY WA OR AND CSTL WTRS
BOUNDED BY 60SW YXC-50WNW HVR-40NW BOY-60SSE LKT-90SW BKE-160NW
FOT-120WNW ONP-140W HQM-40S YDC-60SW YXC
MOD TURB BLW FL180. CONDS CONTG THRU 21Z.

As noted above, step 205 of the method shown in FIG. 2 may include presenting the relevant data layer(s). That is, the computer system 110 may display the relevant data layer(s) selected in step 204 on the display 120, which may be on-board the vehicle. Alternatively, if the computer system 110 is off-board the vehicle, the computer system 110 may present the relevant data layer(s) by transmitting the relevant data layer(s), or a data describing a graphical representation thereof, to the vehicle such that the relevant data layer(s) is displayed on display 120 on-board the vehicle. In either case, the relevant data layer(s) may be presented to an operator of the vehicle, such as a member of the flight crew.

A display of a data layer may include a representation of the condition indicated by the relevant data layer. A representation of a condition may, for example, have a visually depicted area representing the area of the condition, such as the boundaries of a weather condition or the boundaries of a zone subjected to a flight restriction.

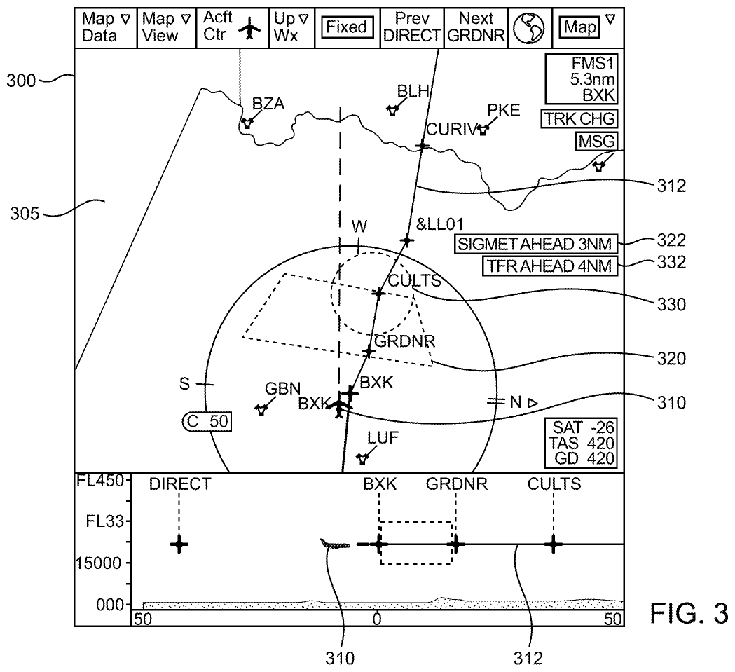

Examples of modes of display are discussed below. Examples of displays of data layers are shown in FIGS. 3, 6 and 7, also discussed below.

As one possible mode of display, the computer system 110 may display multiple data layers simultaneously on display 120. For example, the data analyzer 111 may determine that five layers from three sources are relevant for display. In this example, the three sources may be on-board radar, SXM and GDC Uplink, and the five layers may be a Radar scan from an on-board radar, SIGMET from SXM, METAR from the SXM, TFR from a GDC Uplink, and winds from the GDC link. Data for these five layers may be provided to a graphics module on the aircraft, which may then render these layers from different sources simultaneously for display on display 120 so as to perform a sensor/data fusion from the three different sources. Accordingly, layers of more than one weather source, rather than layers of only one weather source, are rendered for display.

As another mode of displaying weather conditions, the computer system 110 may control the display 120 to perform a looped display of different data layers. For example, the data analyzer 111 has determined multiple data layers to be being relevant, such as ten layers. In such situations, the graphics module may not be capable of processing and displaying all ten layers simultaneously; even if it could, displaying all ten layers may result in a highly cluttered display. Instead of displaying all ten layers simultaneously, the computer system 110 may divide the ten layers into multiple sets of one or more layers, and loop through the sets every few seconds. For example, of the ten layers, the first three data layers may be displayed for two seconds, then the next three for two seconds, and the final four layers for three seconds. This sequence may be looped continuously, until auto mode is disabled, or if the certain layers are no longer relevant. The grouping of the data layers and the timespan for each set of data layer may be determined based on the characteristic of the data layers or the weather conditions depicted by the layers, and/or the relevance of each of the layers. In some examples, the grouping of data layers and the timespan for each set of data layers may be adjustable by the flight crew.

The computer system 110 and the aircraft may implement one or both of the display modes described above. In some examples, the computer system 110 and the aircraft's display-related components may be capable of both display modes, and may automatically switch to the second display mode if the number of relevant layers is above a certain threshold. Additionally, the display of a weather condition may be animated during this time span to depict the movement of weather phenomena, if the data layer includes an animation or data suitable for animation.

FIG. 3 is an example of a screen 300 that may be displayed on display 120. Screen 300 may be displayed on a display unit of a flight management system or other computer system on an aircraft. The screen 300 shows a map 305, aircraft position 310, and the position of various waypoints (e.g., waypoints BXK, GRNDR, CULTS, and &LL01) along the flight path 312. Map 305 may have various colors corresponding to different terrain elevations.

Screen 300 also displays a representation 320 of a SIGMET data layer and a representation 330 of a TFR data layer overlaid on the map 305. In this example, the representations 320 and 330 are both represented as outlines showing the areas on the map corresponding to the region covered by the SIGMET and TFR. Screen 300 may also display advisory messages corresponding to the SIGMET and TFR, such as advisory message 322 indicating that the SIGMET zone is 3 nautical miles ahead, and advisory message 332 indicating that the TFR zone is 4 nautical miles ahead.

The features shown in screen 300 may be displayed when the data analyzer 111 has identified the TFR and SIGMET layers of the SXM source as the most relevant layers. The data analyzer 111 may provide data for the layers to the graphics module, which may automatically display these two layers to the flight crew (even if SXM was not selected) as shown. Accordingly, the flight crew is immediately alerted to take necessary action. While the representations 330 and 320 are representations of a SIGMET and TFR, it is noted that various other data layers may be displayed in a similar manner.

FIGS. 4 and 5 illustrate example implementations of the computer system 110 and display 120 shown in FIG. 1.

FIG. 4 illustrates an example implementation in which the computer system 110 of FIG. 1 is implemented on-board aircraft 400 (an example of a vehicle) as on-board computer system 110a. That is, the on-board computer system 110a may have all functionalities described for computer system 110. The on-board computer system 110c may have a map application 112 that generates an output of a map, such as map 305 discussed above, to be displayed on the display. The map application may be part of a graphics module of the aircraft 400. The on-board computer system 110a may be a flight management system. The display 120 may be separate from the computer system 110a or part of the computer system 110a.

FIG. 5 illustrates an example implementation in which at least part of the computer system 110 of FIG. 1 is implemented off-board the aircraft as off-board computer system 110b. As shown in FIG. 5, the data analyzer 111 may particularly be implemented in the off-board computer system 110b. As described below, the off-board computer system 110b may operate in conjunction with an on-board computer system 110c that is located on-board the aircraft 400. The computer system 110 of FIG. 1 may correspond to either the off-board computer system 110b alone or the combination of both off-board computer system 110b and the on-board computer system 110c.

The off-board computer system 110b may be, for example, a server system located on the ground that provides a weather data analysis service to aircraft 400. The weather data analysis service may be, for example, a subscription service offered to an operator (e.g., airline or other organization) of the aircraft 400. Such service may be referred to as a service for alerting, identification, and display of significant weather phenomena from multiple services.

Off-board computer system 110b may perform steps 201 through 205 shown in FIG. 2. Off-board computer system 110b may perform step 202 (determining whether auto mode is enabled) based on data received from the aircraft 400. For example, the aircraft 400 may transmit a message to the off-board computer system 110b indicating whether auto mode is to be enabled. Off-board computer system 110b may perform step 205 (display of relevant data layer(s)) by transmitting data describing the relevant data layer(s) to aircraft 400 so that the relevant data layer(s) are displayed on the display 120.

The off-board computer system 110b may continuous receive aircraft data 530, which may include data indicating the position of the aircraft 400. Aircraft data 530 may be received from any system that tracks movement of the position of the aircraft. In some examples, the off-board computer system 110b may include an uplink message generator 520 which receives the aircraft data 530. Based on, for example, aircraft data 530 and a selection of significant weather layers by data analyzer 111, the uplink message generator 520 may construct an uplink message 540 for aircraft 400 that identifies significant weather conditions. The uplink message 540 may include coordinates indicating the weather condition and may contain information used by the aircraft 400 to generate advisory messages, along with representations of any weather condition determined to be relevant, for display on display 120. The uplink message 540 may be customized to the particular aircraft 400 (e.g., based on aircraft data 530 that is specific to aircraft 400).

The uplink message generator 520 may be a software application that is executed by the off-board computer system 110b. The off-board computer system 110b may further include a communication interface by which custom messages generated by the uplink message generator 520 is transmitted to the aircraft 400 through an electronic network. For example, the communication interface may generate packets of data describing the uplink message 540.

As shown in FIG. 5, the on-board computer system 110c (e.g., a flight management system) of the aircraft 400 may receive the uplink message 540. For example, the on-board computer system 110c may decode the packets of data describing the uplink message 540, and generate an output to be displayed on display 120.

According to the implementation shown in FIG. 5, data 131 may be processed by an off-board computer system 110b such that layers of low relevance may be omitted from being displayed on display 120. The particularly layers that are displayed on 120, may be those selected by the off-board computer system 110b in a manner that suits the particular aircraft's avionics and display systems capabilities.

The uplink message 540 may allow the off-board computer system 110b to support legacy aircraft that have datalink capability, but do not have the processor graphics capabilities to display computationally or graphically intensive layers from certain sources, such as SXM and certain data center of certain data centers. For example, the off-board computer system 110 may uplink a small data packet that includes data indicating geographical coordinates of a zone and additional data to indicate type of zone (e.g., TFR, SIGMET, etc.). Such packet may have a low memory requirement and a graphical footprint that is suitable for the aircraft's hardware capabilities. The on-board computer system 110c may receive the uplink message and construct the graphical primitives so that the display application can render the zone as shown in.

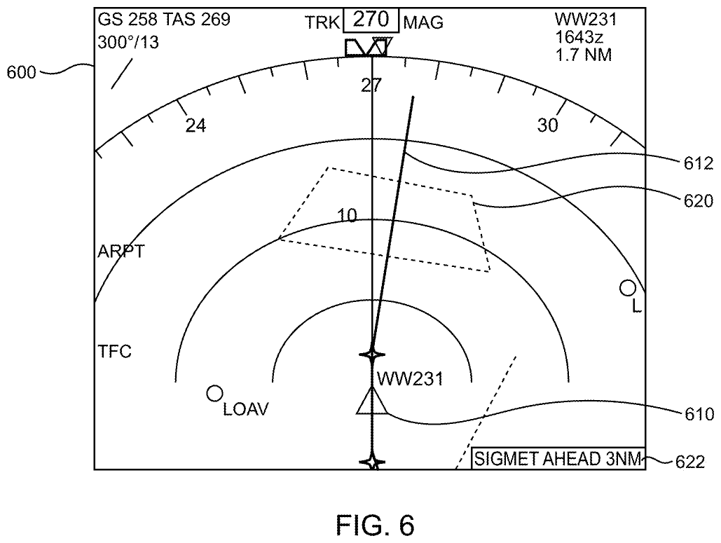

FIG. 6 illustrates a screen 600 of display 120 of a fight management system (on-board computer system 110c) rendering a zone 620 based on coordinates included in an uplink message 540 provided by off-board computer system 110b. The screen 600 also displays aircraft position 610, flight path 612, and advisory message 622. The advisory message 622 may also be displayed based on the uplink message 540. In FIG. 5, the zone 620 is exemplified as a SIGMET zone, and the advisory message 622 is exemplified as a message indicating the distance to this SIGMET zone. However, the zone 620 may indicate another type of condition.

Accordingly, the off-board computer system 110b may provide enhanced situational awareness to the flight crew of aircraft 400 even if the aircraft 400 is a legacy aircraft that does not possess computational or graphical capabilities of parsing through data from certain weather sources, such as SXM and certain data center sources. Additionally, since only relevant weather phenomena that is conflicting with the aircraft's path is uplinked by the off-board computer system 110b and displayed on the display 120 of the aircraft, the bandwidth requirements may be reduced.

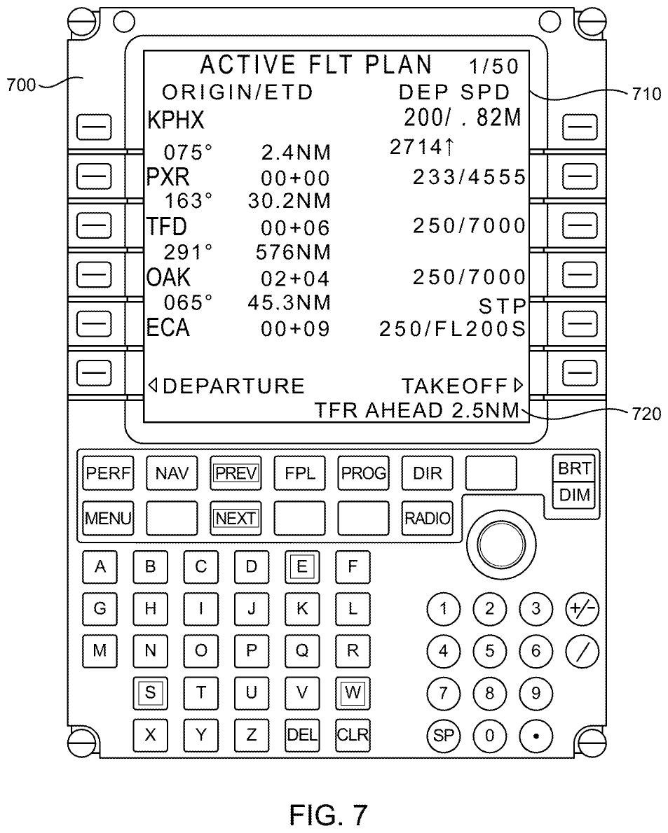

As noted above, in addition or alternative to custom graphical message uplinks, the off-board computer system 110b could also send message uplinks to the subscribed aircraft. FIG. 7 illustrates an example of a display 700 of a flight management system (on-board computer 550) displaying a screen 710 having a message 720 indicating a potential conflict with an upcoming zone. Displaying such a message 720 immediately alerts the flight crew and provides adequate time to adjust the route. Display 700 serves an example of display 120. In FIG. 7, the display 700 is depicted as a text-only display device, such as a Multi-Function Control and Display Unit (MCDU).

According to the methods and systems described in this disclosure, it is possible to automatically identify and display data layers that are most relevant to a vehicle. Therefore, even if there is a large number of data layers from multiple data sources, the operator of a vehicle, such as an aircraft flight crew, may be presented with the most relevant data layers. Furthermore, the computer system 110 may provide an auto mode setting, such that the operator of the vehicle may choose whether the automatic identification and display of relevant data layers is enabled. Accordingly, the methods and systems of this disclosure may realize improvement in information-displaying capabilities of aircraft avionics, and analogous systems in other types of vehicles.

In general, any process discussed in this disclosure that is understood to be computer-implementable, such as the processes illustrated in FIG. 2, may be performed by one or more processors of a computer system, such as computer system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as computer system 110, may include one or more computing devices. If the one or more processors of the computer system 110 are implemented as a plurality of processors, the plurality of processors may be included in a single computing device or distributed among a plurality of computing devices. If a computer system 110 comprises a plurality of computing devices, the memory of the computer system 110 may include the respective memory of each computing device of the plurality of computing devices.

A computing device may include processor(s) (e.g., CPU, GPU, or other such processing unit(s)), a memory, and communication interface(s) (e.g., a network interface) to communicate with other devices. Memory may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory. The computing device may, in some embodiments, further include input device(s) (e.g., a keyboard, mouse, or touchscreen) and output device(s) (e.g., a display, printer). The aforementioned elements of the computing device may be connected to one another through a bus, which represents one or more busses. In some embodiments, the processor(s) of the computing device include both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for identifying and presenting data layers relevant to a vehicle, the method comprising:
receiving data describing a plurality of data layers, each of the plurality of data layers being indicative of a condition being a weather condition or a restriction zone condition;
determining a relevance of each of the plurality of data layers based on a position or planned path of the vehicle and characteristics of the conditions respectively indicated by the plurality of data layers;
selecting one or more relevant layers from the plurality of data layers based on the relevance respectively determined for the plurality of data layers; and
presenting the one or more selected relevant data layers to an operator of the vehicle.

2. The method of claim 1, wherein
the plurality of data layers include a plurality of weather layers each indicative of a respective weather condition, and
for each of the plurality of weather layers, the respective relevance is determined based on a severity of the respective weather condition.

3. The method of claim 2, wherein
the plurality of weather layers include a first weather layer indicative of a first weather condition having a quantified characteristic, and
the determining the relevance of each of the plurality of data layers includes determining the respective severity of the first weather condition by determining whether the quantified characteristic satisfies a significance threshold.

4. The method of claim 1, wherein
the plurality of data layers includes a first plurality of data layers and a second plurality of data layers, and
the receiving the data includes:
receiving, from a first data source, first data describing the first plurality of data layers; and
receiving, from a second data source, second data describing the second plurality of data layers.

5. The method of claim 1, wherein the presenting the one or more selected relevant data layers includes displaying the one or more selected data layers on a display of the vehicle.

6. The method of claim 5, wherein
the one or more selected relevant layers is a plurality of relevant data layers, and
the displaying includes looping through sets of data layers, each of the sets including one or more of the plurality of relevant data layers.

7. The method of claim 1, wherein the presenting the one or more selected relevant data layers includes:
generating an uplink message including data describing a graphical representation of each of the one or more selected relevant layers; and
transmitting the uplink message to the vehicle so that the vehicle displays the graphical representation of each of one or more selected relevant layers.

8. A computer system for identifying and presenting data layers relevant to a vehicle, the computer system comprising:
a memory storing instructions; and
one or more processors configured to execute the instructions to perform operations including:
receiving data describing a plurality of data layers, each of the plurality of data layers being indicative of a condition being a weather condition or a restriction zone condition;
determining a relevance of each of the plurality of data layers based on a position or planned path of the vehicle and characteristics of the conditions respectively indicated by the plurality of data layers;
selecting one or more relevant layers from the plurality of data layers based on the relevance respectively determined for the plurality of data layers; and
presenting the one or more selected relevant data layers to an operator of the vehicle.

9. The computer system of claim 8, wherein
the plurality of data layers include a plurality of weather layers each indicative of a respective weather condition, and
for each of the plurality of weather layers, the respective relevance is determined based on a severity of the respective weather condition.

10. The computer system of claim 9, wherein
the plurality of weather layers include a first weather layer indicative of a first weather condition having a quantified characteristic, and
the determining the relevance of each of the plurality of data layers includes determining the respective severity of the first weather condition by determining whether the quantified characteristic satisfies a significance threshold.

11. The computer system of claim 10, wherein
the plurality of data layers includes a first plurality of data layers and a second plurality of data layers, and
the receiving the data includes:
receiving, from a first data source, first data describing the first plurality of data layers; and
receiving, from a second data source, second data describing the second plurality of data layers.

12. The computer system of claim 8, wherein the presenting the one or more selected relevant data layers includes displaying the one or more selected data layers on a display of the vehicle.

13. The computer system of claim 12, wherein
the one or more selected relevant layers is a plurality of relevant data layers, and
the displaying includes looping through sets of data layers, each of the sets including one or more of the plurality of relevant data layers.

14. The computer system of claim 8, wherein the presenting the one or more selected relevant data layers includes:
generating an uplink message including data describing a graphical representation of each of the one or more selected relevant layers; and
transmitting the uplink message to the vehicle so that the vehicle displays the graphical representation of each of one or more selected relevant layers.

15. A non-transitory computer-readable medium storing instructions that, when executed by one or more processors, cause the one or more processors to perform a method for identifying and presenting data layers relevant to a vehicle, the method including:
receiving data describing a plurality of data layers, each of the plurality of data layers being indicative of a condition being a weather condition or a restriction zone condition;
determining a relevance of each of the plurality of data layers based on a position or planned path of the vehicle and characteristics of the conditions respectively indicated by the plurality of data layers;
selecting one or more relevant layers from the plurality of data layers based on the relevance respectively determined for the plurality of data layers; and
presenting the one or more selected relevant data layers to an operator of the vehicle.

16. The non-transitory computer-readable medium of claim 15, wherein
the plurality of data layers include a plurality of weather layers each indicative of a respective weather condition, and
for each of the plurality of weather layers, the respective relevance is determined based on a severity of the respective weather condition.

17. The non-transitory computer-readable medium of claim 16, wherein
the plurality of weather layers include a first weather layer indicative of a first weather condition having a quantified characteristic, and
the determining the relevance of each of the plurality of data layers includes determining the respective severity of the first weather condition by determining whether the quantified characteristic satisfies a significance threshold.

18. The non-transitory computer-readable medium of claim 15, wherein
the plurality of data layers includes a first plurality of data layers and a second plurality of data layers, and
the receiving the data includes:
receiving, from a first data source, first data describing the first plurality of data layers; and
receiving, from a second data source, second data describing the second plurality of data layers.

19. The non-transitory computer-readable medium of claim 15, wherein the presenting the one or more selected relevant data layers includes displaying the one or more selected data layers on a display of the vehicle.

20. The non-transitory computer-readable medium of claim 15, wherein the presenting the one or more selected relevant data layers includes:
generating an uplink message including data describing a graphical representation of each of the one or more selected relevant layers; and
transmitting the uplink message to the vehicle so that the vehicle displays the graphical representation of each of one or more selected relevant layers.
